(19) United States
(12) Patent Application Publication
(10) Pub. No.: US 2004/0140988 A1
(43) Pub. Date: Jul. 22, 2004

(54) Computing system and device having interactive projected display

(76) Inventor: David Kim, Santa Clara, CA (US)

Correspondence Address: Karl M. Steins, Steins & Associates, Suite 120, 2333 Camino del Rio South, San Diego, CA, 92108, US

(21) Appl. No.: 10/438,110

(22) Filed: May 13, 2003

Related U.S. Application Data
(60) Provisional application No. 60/441,269, filed on Jan. 21, 2003.

(51) Int. Cl. G09G 5/00

(52) U.S. Cl. 345/700

(57) ABSTRACT

A Computing System and Device Having Interactive Projected Display is disclosed. Also disclosed is a device and system that enables a small handheld device to project a display screen image that is full-sized without the need for auxiliary equipment. The device has an output device that projects a high quality image and an input device that permits the user to interact directly with the projected screen image. The input systems may include a wide variety of tactile input methods, including touching the projected image, gesturing in close proximity to the projected image, and/or using a specialized pointer of mouse to send inputs to the system.

### CLAIM FOR PRIORITV TO PROVISIONAL APPLICATION—35 U.S.C. §111(b)

This application claims priority to Provisional Patent Application 60/441,269 filed Jan. 21, 2003.

### BACKGROUND OF THE INVENTION

1. Field of the Invention

This invention relates generally to input/output systems for computing devices and, more specifically, to a Computing System and Device Having Interactive Projected Display.

2. Description of Related Art

The world of mobile computing has expanded dramatically with the evolution of notebook computers and personal digital assistance (PDA's) and their ability to now provide more functionality and information, and therefore productivity to users when they are away from their home or office. In fact, many users have replaced their desktop computers with notebook computers, having actually increased their available computing power in doing so. Although PDA's have also evolved, their input/output limitations (mainly due to display size constraints) have substantially limited their functionality. The strength of the PDA is its extremely compact and convenient size; the strength of the notebook is its power. The problem is that the power applications are coupled with ergonomic size constraints, making even the notebook computer too large to be truly convenient as a mobile device, while the I/O limitations of the PDA have prevented it from becoming a replacement for a PC or notebook computer.

Several approaches to handheld, portable power computing have emerged, but all with significant tradeoffs to the user. Pans that record and later download what was written into software are small, but limited. Handheld projectors using LED sources can project simple, fixed images, but no motion or interaction. Projection eyewear is an alternative for military or hospital applications, but distractive and unproven in the mainstream.

What is needed is a device and method of providing a projected display and associated input subsystem that will enable interactivity with the projected application, will overcome these defects in the prior systems and therefore will provide substantial additional utility for projection displays.

### SUMMARY OF THE INVENTION

In light of the aforementioned problems associated with the prior systems and devices, it is an object of the present invention to provide a Computing System and Device Having Interactive Projected Display. The device and system should enable a small handheld device to project a display screen image that is full-sized without the need for auxiliary equipment. The device should have an output device that projects a high quality image and an input device that permits the user to interact directly with the projected screen image. The input systems should include a wide variety of tactile input methods, including touching the projected image, gesturing in close proximity to the projected image, and/or using a specialized pointer of mouse to send inputs to the system.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIG. 1 is a modular depiction of the main functional components of the present invention and their interrelationships;

FIG. 2 is a perspective view of one embodiment of the device and system of the present invention;

FIG. 3 is a close-up perspective view of the device of FIG. 2;

FIG. 4 is a depiction of the functional components of the input portion of the device of FIGS. 1-3;

FIG. 5 is a depiction of the functional components of the output portion of the device of FIGS. 1-3; and

FIG. 6 depicts the interaction between the input and output portions of the present invention.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the generic principles of the present invention have been defined herein specifically to provide a Computing System and Device Having Interactive Projected Display.

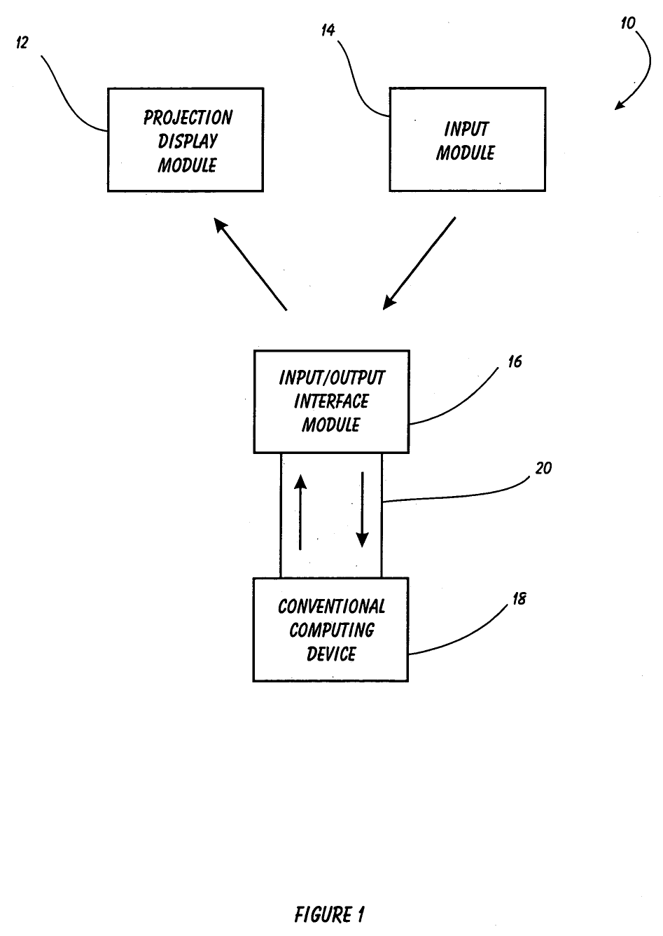

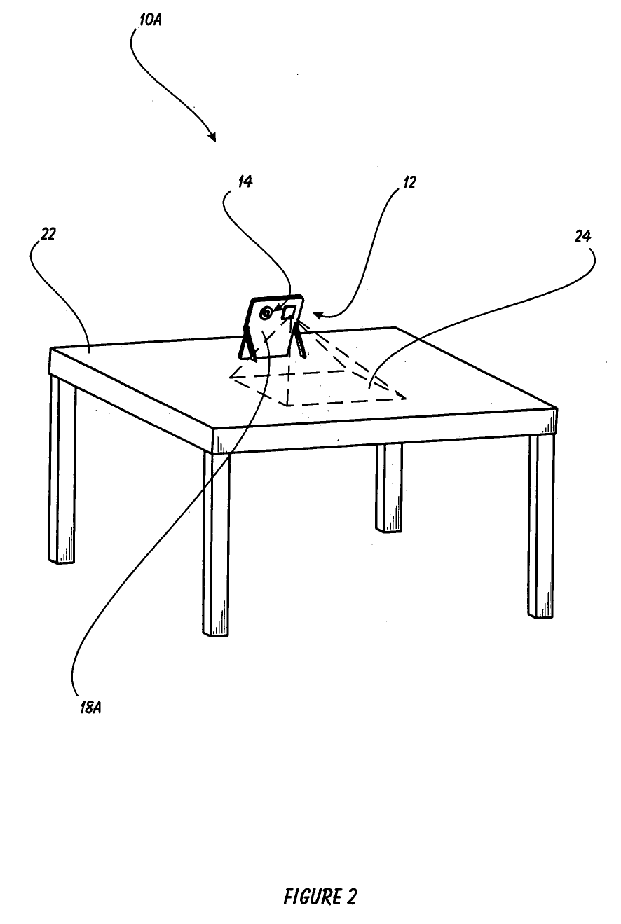

The present invention can best be understood by initial consideration of FIG. 1. FIG. 1 is a modular depiction of the main functional components of the present invention and their interrelationships. From a functional standpoint, at its most basic form, the computing device having an interactive projected display 10 comprises a projection display module 12 and an input module 14. These two modules coordinate with one another and communicate with external systems via an input/output interface module 16. The I/O interface module 16 communicates with a computing device 18 via an input/output connection 20. If we turn to FIG. 2, we can begin to discuss specific physical embodiments of the present invention.

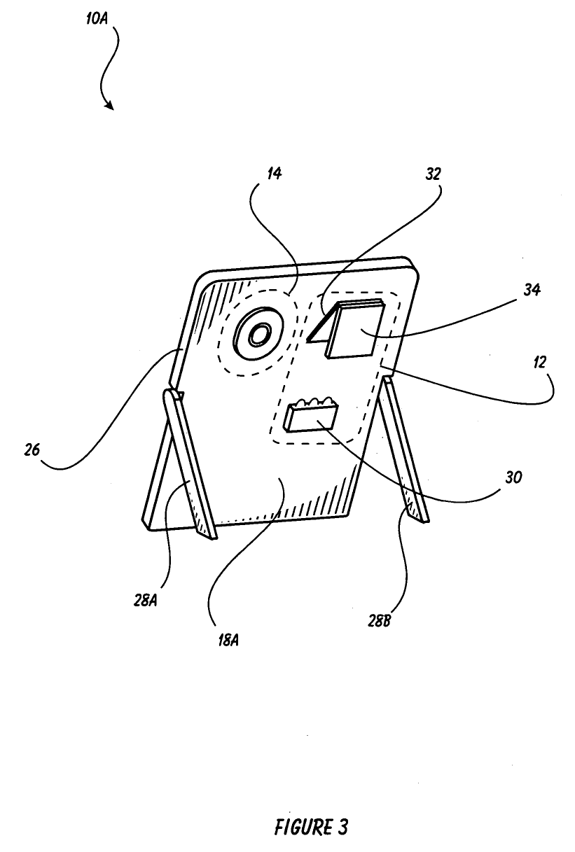

FIG. 2 is a perspective view of one embodiment of the device and system of the present invention. In this embodiment of the device 10A, the computing device 18A has the projection input/output system of the present invention incorporated within it. The device 10A here is a modified palm-sized PDA computing device 18A. The device 10A is configured to rest on a horizontal surface, such as the tabletop 22 shown, in an orientation that allows the projection display module 12 to project a display image 24 onto the surface 22. As will be discussed further below, the input module 14 is positioned within the device 10A such that it can view the projected display image 24 and receive input commands for operating the computing device 18A by user interaction with the actual display image 24 itself. Even from this introduction to this single embodiment, it should be apparent that the handheld PDA having the interactive projected display provided by the present invention will provide much of the ergonomic utility of the conventional desktop personal computer, without the bulk of that unit. FIG. 3 provides yet additional detail. It should be appreciated that the display image 24 can be projected on a flat surface having any orientation, and that it is not limited to horizontally oriented surfaces.

FIG. 3 is a close-up perspective view of the device 10A of FIG. 2. The device 10A has a palm-sized housing 26 and a pair of retractable legs 28A and 28B. The legs 28 are designed to provide the desired cant to the device 10A such that the projection display module 12 and input module 14 are aimed at the horizontal surface upon which the device 10A is resting. These legs 28 can be retracted by simply folded back into pockets formed in the housing 26 in order to provide a very smooth and condensed package for ease and comfort in carrying. Of course, this is only one example of a device and method of deploying the projected display module 12 and input module 14. Many other concepts are possible, such as swing arm (??), flip-out hinged array (??), calibrated foot (??).

Although not shown here, essentially the rest of the computing device 18A is identical to a conventional PDA, such that a user might also be able to interact with the conventional PDA in those circumstances where a projected display and associated input method are not desired.

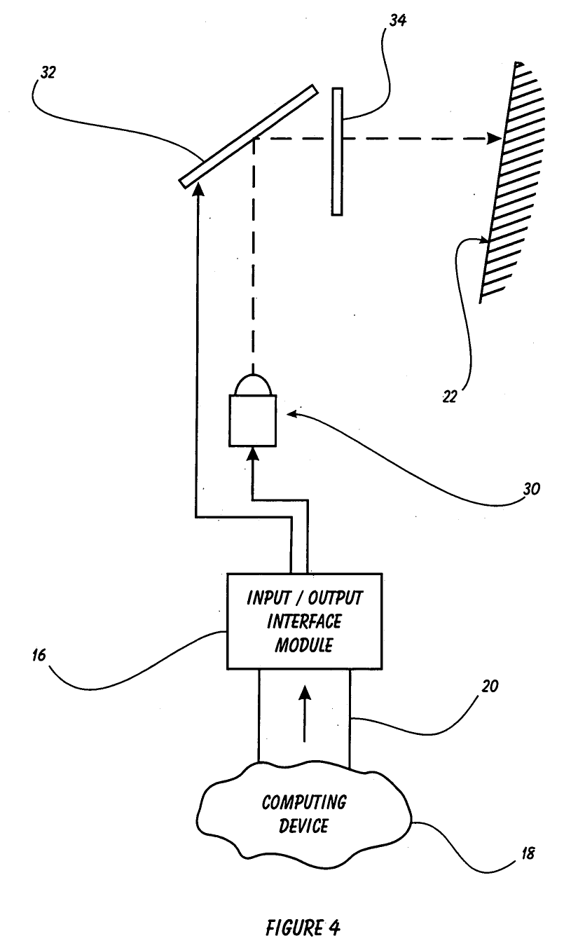

FIG. 4 is a depiction of the functional components of the input portion of the device of FIGS. 1-3. The projection display module 12 of this embodiment comprises three major components: a modulated light source 30, an image engine 32, and a lens means 34 for converting the generated raw image into a finished, legible display having mainstream-quality resolution. In other embodiments, other versions of the light source 30 (even non-modulated types) may be used.

The modulated light source 30 is one or more array(s) of red, green, blue and/or white lights. The lights may be conventional Light Emitting Diodes (LED's) or laser(s); these two sources provide exceptional light power with low power demand while virtually eliminating the overheating issues characteristic of the prior projectors. The term “modulated” refers to the characteristic of the source 30 of intermittently lighting or scanning each light in repeating form; when a visible light is blinked or scanned at a rate of 60 Hz or more, the light is perceived by the human eye as being constantly on. By scanning or blinking the lights rather than leaving them on continuously, the lights provide greater brightness and further will have improved longevity.

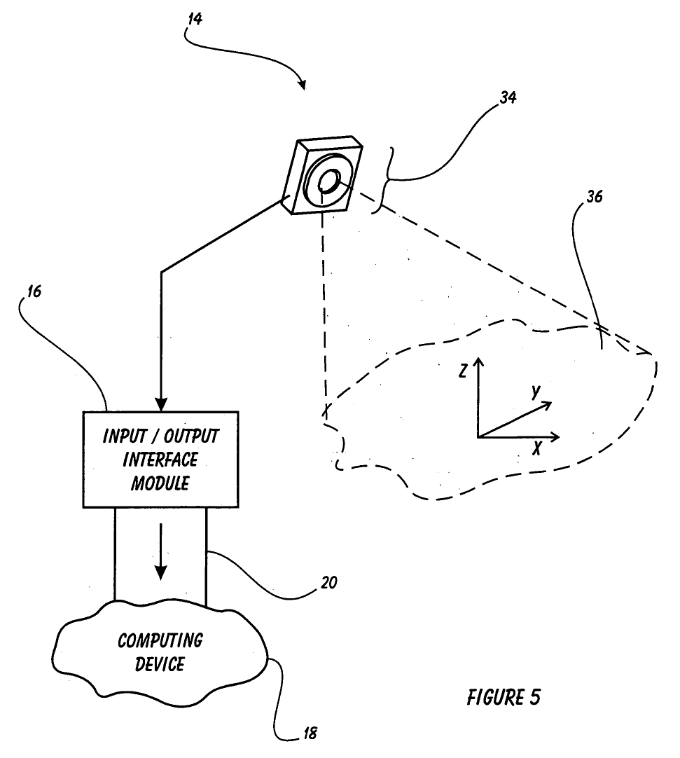

The image engine 32 may comprise a variety of forms, but in this depiction is a Digital Light Processor, or DLP. The DLP or other image engine 32 cooperates with the modulated light source 30 to reflect the appropriate incident light at the appropriate frequency and of the proper color to create a stable image at the desired orientation to match the chosen projection surface. Depending upon which other elements are selected in the projection display module 12, there may also be a lens means 34 for further modifying and improving the image being projected on the projection surface. In particular, this lens means 34 is a progressive lens, of the type particularly chosen to adjustably convert a rectangular image into a trapezoid such that it will appear as a rectangle when projected onto the display surface 22. As is depicted here by solid lines terminating in arrowheads, the Input/Output Module 16 controls not only the modulated light source 30, but also the image engine 32 in order to create and manipulate the displayed image. Now turning to FIG. 5, we can examine the input side of the system.

FIG. 5 is a depiction of the functional components of the output portion of the device of FIGS. 1-3. The input module 14 of this embodiment comprises a special position detector means, such as either a CMOS camera or a CCD camera that has the ability to observe the activity occurring within its view. In particular, the camera would determine where, in a spacial sense, the user has touched the displayed image; the input module 14 takes the observed position and delivers it to the I/O interface module for conversion into a format for use by the computing device as a pointer input. Use of a CMOS or CCD camera for visually conducting surveillance on the detection volume 36 enables the system to detect movement and position in three axes. The detection in three axes provides the system with both movement and position with substantial accuracy; as such, the user's desired input commands can be more reliably interpreted. Furthermore, the camera may be used to provide the projection display module with feedback in order to fine tune the displayed image based on actual detected image quality.

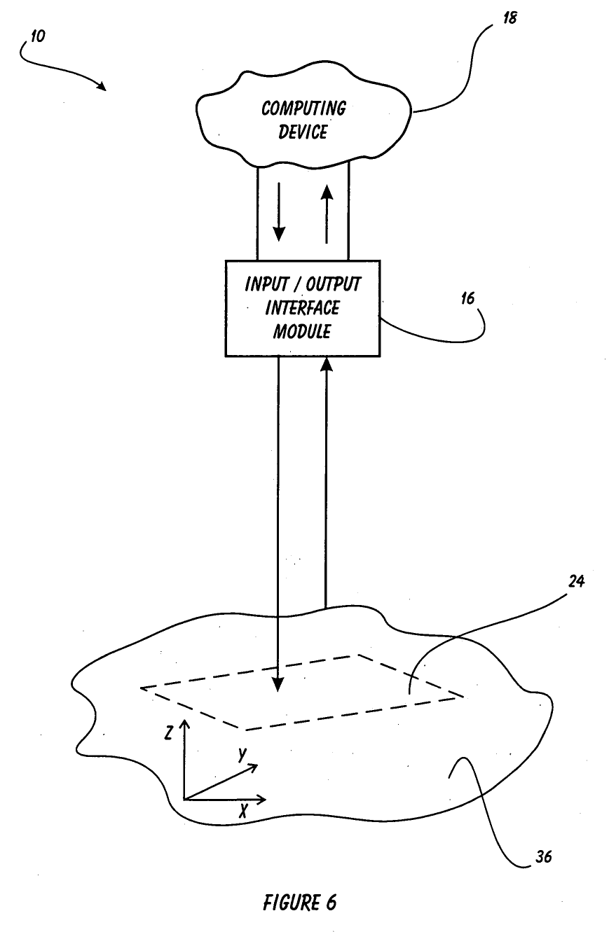

In other versions, a position detector having less capability than those previously described may be employed, an example being 2-dimensional detection plus input from a modulated stylus or pointer, such as a device for detecting the location of the tip and/or orientation of a specialized stylus or pointer being used by the user to enter commands and other inputs. Finally, turning to FIG. 6, we can examine the operation of the input and display systems.

FIG. 6 depicts the interaction between the input and output portions of the present invention. As shown, the detection volume 36 is an overlay for the projected display image 24 so that as the user interacts with the image 24, his or her touches and motions are detected. The Input/Output interface module 16, which comprises the software routines necessary to calibrate the detected command as it is oriented compared to the displayed image.

By interfacing directly on the displayed image, the user's interaction with the computing device's display, the interaction becomes more intuitive, like real painting, writing, drafting, etc. It can be expected to reduce repetitive stress syndrome by allowing a more natural human movement (and larger motions). For example, a user running a spreadsheet program on the computing device having the interactive display system of the present invention will enable the user to see the image of the spreadsheet and then highlight a cell with a pointing device (or by another input method); the instruction to highlight will be detected by the input module and converted to a mouse signal by the I/O interface module for use as an input by the operating system of the computing device. It is expected that many different methods of interacting with the projected image will be used, including physically touching and/or simply gesturing adjacent to the image—collectively, these are referred herein to as tactile interactions with the projected image display.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A computing device, comprising:
at least one storage means for storing electronic data;
a processor means for processing computing instructions;
an output device comprising:
a light source means for projecting a visible image on a projection surface;
a virtual input device comprising:
a position detector means for detecting user input wherein said user input consists of tactilely interacting with said projected image; and
an input/output interface module in communication with said output device, said virtual input device and said processor means.

2. The device of claim 1, wherein said light source means comprises:
a light source; and
an image engine cooperating with said light source to create said projected visible image.

3. The device of claim 1, wherein said light source comprises a modulated light source.

4. The device of claim 1, wherein said position detector means comprises a CMOS camera.

5. The device of claim 1, wherein said position detector means comprises a CCD camera.

6. The device of claim 1, wherein said position detector means comprises at least two cameras, each said camera defining a focal axis, said focal axes defined by the axis of focus of a said camera, said focal axes being separated from each other.

7. An input/output subsystem for integration with a computing device, the subsystem comprising:
a projection display module comprising:
a light source means for creating a projected visible image on a projection surface;
an input module for detecting the position of an article in relation to said projected image; and
an input/output interface module in operative communication with said projection display module, said input module and said computing device.

8. The subsystem of claim 7, wherein said light source means comprises:
a light source; and
an image engine cooperating with said light source to create said projected visible image.

9. The device of claim 8, wherein said light source comprises a modulated light source.

10. The subsystem of claim 9, wherein said modulated light source comprises at least one LED array, each said array comprising at least one red LED, at least one blue LED and at least one green LED.

11. The subsystem of claim 9, wherein said modulated light source comprises at least one LED array of white LED's.

12. The subsystem of claim 7, wherein said input module comprises:
a spacial position detector means for detecting motion in the vicinity of said projected visible image, said detected motion comprising x-axis motion data, y-axis motion data and z-axis motion data.

13. The subsystem of claim 7, wherein said input module comprises:
a stylus; and
a detector for detecting the spacial location of said stylus when said stylus is touched to said projection surface on said projected display.

14. The subsystem of claim 7, wherein said input module detects motion in a three-dimensional detection volume.

15. A computing device, comprising:
a housing, said housing comprising a front face and a rear face, said faces in spaced relation to define a thickness of said housing, said thickness being less than about one inch, and said housing further defining an interior volume;
at least one storage means for storing electronic data, said storage means located in said interior volume;
a processor means for processing computing instructions, said processor means located in said interior volume;
an output device attached to said housing, said output device comprising:
a modulated light source; and
an image engine cooperating with said light source to create a projected visible image on a projection surface;
a virtual input device attached to said housing, said virtual input device comprising:
a position detector means for detecting user input wherein said user input consists of touching said projected image; and
an input/output interface module in communication with said output device, said virtual input device and said processor means.

16. The device of claim 15, wherein said position detector means comprises a CMOS camera.

17. The device of claim 15, wherein said position detector means comprises a CCD camera.

18. The device of claim 15, wherein said position detector means comprises at least two cameras, each said camera defining a focal axis, said focal axes defined by the axis of focus of a said camera, said focal axes being separated from each other.

19. The device of claim 15, further defined by at least one leg means for retaining said housing in a chosen spacial orientation.

20. The device of claim 15, wherein said housing is further defined by a pair of recessed pockets formed therein; and
each said pocket includes one said leg means hingably attached thereto.
